(19) United States
(12) Patent Application Publication
(10) Pub. No.: US 2021/0140446 A1
(43) Pub. Date: May 13, 2021

(54) Diffuser Vane, Compressor Structure and Compressor

(71) Applicants: Gree Electric Appliances (Wuhan) Co., Ltd., Wuhan (CN); Gree Electric Appliances, Inc. of Zhuhai, Zhuhai (CN)

(72) Inventors: Zengyue Liu, Zhuhai (CN); Ruixing Zhong, Zhuhai (CN); Nan Jiang, Zhuhai (CN); Caiyun Jiang, Zhuhai (CN); Yuhui Chen, Zhuhai (CN); Yi Zhou, Zhuhai (CN); Liandong Lei, Zhuhai (CN); Xinwang Ouyang, Zhuhai (CN)

(21) Appl. No.: 16/611,656

(22) PCT Filed: Dec. 22, 2017
(86) PCT No.: PCT/CN2017/118109

§ 371 Date: Nov. 7, 2019

(30) Foreign Application Priority Data
May 11, 2017 (CN) 201710330901.0

(51) Int. Cl. F04D 29/44; F04D 29/42; F04D 29/28

(52) U.S. Cl. CPC F04D 29/444; F04D 29/284; F04D 29/4206

(57) ABSTRACT

The present application discloses a diffuser vane, a compressor structure and a compressor. The diffuser vane includes a vane body, wherein a cavity is formed inside the vane body, and a gas supplement hole is formed on the vane body.

### CROSS-REFERENCE TO RELATED APPLICATIONS

The present disclosure claims priority to China Patent Application No. 201710330901.0 titled “diffuser vane, compressor structure and compressor” and filed on May 11, 2017, the disclosure of which is incorporated by reference herein in its entirety.

### TECHNICAL FIELD

The present application relates to the field of a compressor, and in particular to a diffuser vane, a compressor structure and a compressor.

### BACKGROUND

In a centrifugal compressor, since there may be a sharp rise in temperature after the gas is compressed, and there is a great gas specific volume at a high temperature, the energy consumption of the compressor will increase sharply in the case that the same cooling capacity is ensured. In order to reduce the power consumption of the compressor and improve the cooling capacity, a multi-stage compression refrigeration cycle is commonly used.

At present, the most widely used is the “double-stage compression refrigeration cycle with an intermediate incomplete cooling”, in which a flash steam separator (commonly known as an economizer) is provided. The double-stage compression refrigeration cycle mixes the flash steam separated from the economizer with the exhaust gas from the low-stage compression such that the intake air temperature of the secondary compression is reduced, the gas specific volume of the refrigerant is lowered, and the energy consumption of the compressor is reduced. However, due to a difference in the magnitude and direction of the airflow speed between the main stream and the gas supplement stream, the current gas supplement solution results in a large airflow mixing loss and the aerodynamic efficiency of the compressor is reduced.

In addition, in the centrifugal compressor, the aerodynamic performance of the compressor at a design point may be effectively improved by using a vaned diffuser. However, when the working condition deviates from the design point, as the inlet airflow angle of the diffuser vane varies, it results in that the vane produces a large low-speed and low-energy area, which finally leads to stall and surge of the compressor and reduces a stable operating range of the compressor. By using a vaneless diffuser, although the compressor has a wide operating range, there is a low design-point performance.

### SUMMARY

In an embodiment of the present application, a diffuser vane, a compressor structure and a compressor are provided to reduce an airflow mixing loss brought by gas supplement, and/or reduce a low-speed and low-energy area produced by a suction surface of the diffuser vane when the compressor deviates from a design point.

In order to achieve the above-described object, in an embodiment of the present invention, a diffuser vane is provided. The diffuser vane includes a vane body, wherein a cavity is formed inside the vane body, and a gas supplement hole is formed on the vane body.

In some embodiments, the gas supplement hole is disposed on a suction surface of the vane body.

In some embodiments, the vane body is made by casting or machining.

In the present application, a compressor structure is also provided. The compressor structure includes the above-described diffuser vane.

In some embodiments, the compressor structure further includes a housing, on which a gas supplement passage in communication with the cavity of the diffuser vane is formed.

In some embodiments, the compressor structure further includes a primary impeller and a secondary impeller, wherein the compressor structure is configured to allow an output airflow of the primary impeller enters the secondary impeller through a primary diffuser provided with the diffuser vane.

In some embodiments, the compressor structure is configured to allow the output airflow of the primary diffuser enters the secondary impeller through a flow passage of a reflux.

In some embodiments, a transition between a flow passage of the primary diffuser and the flow passage of the reflux is formed as a curve.

In some embodiments, a secondary diffuser is mounted on an output end of the secondary impeller.

In the present application, a compressor is also provided. The compressor structure includes the above-described compressor structure.

The present application may form a jet flow on a suction surface of the diffuser vane by way of gas supplement by the diffuser vane having a hollow structure as well as the gas supplement hole in the back thereof, so as to blow off a low-speed and low-energy area formed on the suction surface, and reduce an airflow mixing loss brought by gas supplement, thereby further improving the aerodynamic efficiency of the centrifugal compressor and enabling to widen the operating range of the compressor whilst improving the aerodynamic performance of the compressor at the design-point.

### BRIEF DESCRIPTION OF THE DRAWINGS

FIG. 1 is a schematic view showing an axial force balance structure of a compressor rotor according to an embodiment of the present application;

FIG. 2 is a schematic cross-sectional view of a diffuser vane according to an embodiment of the present application;

FIG. 3 is a schematic triangular view of an impeller exit speed according to an embodiment of the present application.

### LIST OF REFERENCE SIGNS

1—vane body;

2—cavity;

3—gas supplement hole;

4—diffuser vane;

5—gas supplement passage;

6—primary impeller;

7—secondary impeller;

8—flow passage of reflux;

9—flow passage of primary diffuser;

10—vane of reflux;

11—flow passage of secondary diffuser;

12—vane of secondary diffuser;

13—volute.

### DETAILED DESCRIPTION

The present application is further described in detail below with reference to the accompanying drawings and specific embodiments, but not as a delimitation on the present application.

It is an object of the present application to reduce an airflow mixing loss brought by gas supplement and enable to widen the operating range of the compressor whilst improving the performance at the design-point. To this end, in an embodiment of the present invention, a diffuser vane is provided. The diffuser vane includes a vane body 1, wherein a cavity 2 is formed inside the vane body 1, and a gas supplement hole 3 is formed on the vane body 1. In some embodiments, the gas supplement hole 3 is disposed on a suction surface of the vane body 1. In some embodiments, the vane body 1 is made by casting or machining.

Please referring to FIGS. 1-3, when the compressor is operating at a design-point working condition, after the refrigerant gas passes through the primary impeller 6, the absolute velocity C of the airflow consists of Cm and Ct since the refrigerant performs a circular motion along with the impeller. The refrigerant airflow enters the flow passage 9 of the primary diffuser at an absolute speed, to impact the diffuser vane at a small attack angle. When the diffuser vane of the present application is not used, if the compressor deviates from the design-point working condition, the absolute airflow angle a of the refrigerant at an outlet of the impeller decreases, and the airflow impacts the vane at a large attack angle, which results in separation of the airflow on the suction surface of the vane and leads to a large low-speed and low-energy area, which finally results in stall and surge of the compressor. In FIG. 3, W is a relative speed, U is a rotational speed, C is an absolute speed, and W+U=C.

In the present application, the diffuser vane 4 is designed to be hollow, and a miniaturized gas supplement inlet 3 is provided on the back of the diffuser vane 4. Accordingly, a jet flow may be formed on a suction surface of the diffuser vane 4 by way of gas supplement, so as to blow off a low-speed and low-energy area formed on the suction surface, and reduce an airflow mixing loss brought by gas supplement, thereby further improving the aerodynamic efficiency of the centrifugal compressor and enabling to widen the operating range of the compressor whilst improving the aerodynamic performance of the compressor at the design-point.

Further, by reasonably designing a position, angle and aperture size of the gas supplement hole 3, that is, by reasonably arranging a position, angle and speed of the jet flow, it is possible to effectively suppress the separation of the airflow on the suction surface of the diffuser vane under a non-design-point working condition.

In the present application, a compressor structure is also provided. The compressor structure includes the above-described diffuser vane 4. In some embodiments, the compressor structure further includes a housing, on which a gas supplement passage 5 in communication with the cavity 2 of the diffuser vane 4 is formed.

Under the diffusing effect of the diffuser vane, the stroke of the airflow in the flow passage 9 of the primary diffuser is reduced, thereby reducing the losses such as the friction, and improving the total pressure recovery coefficient of the diffuser. At the same time, a jet flow is formed on a suction surface of the diffuser vane 4 by way of gas supplement, so as to blow off a low-speed and low-energy area formed on the suction surface, reduce an airflow separation loss, and improve the aerodynamic efficiency of the compressor.

In some embodiments, the compressor structure further includes a primary impeller 6 and a secondary impeller 7, wherein an output airflow of the primary impeller 6 enters the secondary impeller 7 through a primary diffuser provided with the diffuser vane 4. In some embodiments, the output airflow of the primary diffuser enters the secondary impeller 7 through a flow passage 8 of a reflux. In some embodiments, a transition between a flow passage of the primary diffuser and the flow passage 8 of the reflux is formed as a curve. In some embodiments, a secondary diffuser is mounted on an output end of the secondary impeller 7. During operation, the airflow is discharged by a volute 13 after sequentially passing through the primary impeller 6, a flow passage 9 of the primary diffuser, a flow passage 8 of the reflux, the secondary impeller 7, and a flow passage 11 of the secondary diffuser. A vane 12 of the secondary diffuser vane is provided in a flow passage 11 of the secondary diffuser, and a vane 10 of the reflux is provided in a flow passage 8 of the reflux.

By way of the above-described design, the gas supplement by the jet flow in the back of the diffuser vane 4 may effectively reduce a temperature and specific volume of the refrigerant at an outlet of the primary impeller 6, and improve the aerodynamic efficiency of the secondary impeller.

In the present application, a compressor is also provided. The compressor includes the above-described compressor structure.

By way of the present design, the gas supplement by the jet flow on the back of the diffuser vane 4 may effectively reduce a temperature and specific volume of the refrigerant at an outlet of the first impeller 6, and improve the aerodynamic efficiency of the secondary impeller. By diffusion of the diffuser vane 4, the stroke of the airflow in the flow passage of the primary diffuser may be reduced, thereby reducing the losses such as the friction, and improving the total pressure recovery coefficient of the diffuser. Further, a jet flow is formed on a suction surface of the diffuser vane 4 by way of gas supplement by a hollow structure of the diffuser vane 4 as well as the gas supplement hole on the back thereof, so as to blow off a low-speed and low-energy area formed on the suction surface, reduce an airflow separation loss, and improve the aerodynamic efficiency of the compressor.

Of course, the above is a preferred embodiment of the present application. It should be noted that those skilled in the art may also make several improvements and refinements without departing from the basic principles of the present application, which improvements and refinements are also considered to be the protection scope of the present application.

1. A diffuser vane, comprising a vane body, wherein a cavity is formed inside the vane body, and a gas supplement hole is formed on the vane body.

2. The diffuser vane according to claim 1, wherein the gas supplement hole is disposed on a suction surface of the vane body.

3. The diffuser vane according to claim 1, wherein the vane body is made by casting or machining.

4. A compressor structure, comprising the diffuser vane according to claim 1.

5. The compressor structure according to claim 4, further comprising a housing, on which a gas supplement passage in communication with the cavity of the diffuser vane is formed.

6. The compressor structure according to claim 4, further comprising a primary impeller and a secondary impeller, wherein the compressor structure is configured to allow an output airflow of the primary impeller enters the secondary impeller through a primary diffuser provided with the diffuser vane.

7. The compressor structure according to claim 6, wherein the compressor structure is configured to allow the output airflow of the primary diffuser enters the secondary impeller through a flow passage of a reflux.

8. The compressor structure according to claim 7, wherein a transition between a flow passage of the primary diffuser and the flow passage of the reflux is formed as a curve.

9. The compressor structure according to claim 7, wherein a secondary diffuser is mounted on an output end of the secondary impeller.

10. A compressor, comprising the compressor structure according to claim 4.
